(19) United States
(12) Patent Application Publication
(10) Pub. No.: US 2022/0305466 A1
(43) Pub. Date: Sep. 29, 2022

(54) NOx REDUCING CATALYST AND EXHAUST GAS PURIFICATION SYSTEM FOR VEHICLE

(71) Applicants: Hundai Motor Company, Seoul (KR); Kia Corporation, Seoul (KR)

(72) Inventors: Hyokyung Lee, Anyang (KR); Dalyoung Yoon, Seongnam (KR)

(21) Appl. No.: 17/454,661

(22) Filed: Nov. 12, 2021

(30) Foreign Application Priority Data
Mar. 26, 2021 (KR) 10-2021-0039390

(51) Int. Cl. B01J 23/44; B01J 23/10; B01J 21/06; B01J 35/00; F01N 3/20

(52) U.S. Cl. CPC B01J 23/44; B01J 23/10; B01J 21/066; B01J 35/0006; F01N 3/20; F01N 2570/14

(57) ABSTRACT

Disclosed are a NOx reducing catalyst including a carrier including a cerium-zirconium composite oxide, and the palladium supported on the carrier. The catalyst includes palladium in an amount of about 1 wt% to about 5 wt% based on the total weight of the catalyst.

### CROSS-REFERENCE TO RELATED APPLICATION

This application claims priority to and the benefit of Korean Patent Application No. 10-2021-0039390 filed in the Korean Intellectual Property Office on Mar. 26, 2021, the total contents of which are incorporated herein by reference.

### TECHNICAL FIELD

The present invention relates to an NOx reducing catalyst and an exhaust gas purification system for a vehicle including the same, in particular, to an NOx reducing catalyst exhibiting excellent reduction performance of NOx discharged in a cold start region, a low temperature region at the initial start-up period and an exhaust gas purification system for a vehicle including the same.

### BACKGROUND

As regulations on exhaust gas become more stringent, performance of catalysts at the initial start-up is increasingly important. However, since three way catalysts (TWC) take some time until activated, most of the exhaust gas is exhausted after the start-up before the activation.

In order to compensate for this, adsorption or absorption-type catalysts have been developed. These catalysts adsorb or absorb exhaust gas components at the initial start-up of a vehicle and thus suppress emission of the exhaust gas during the warm-up of the three way catalysts.

For example, an NOx storage catalyst absorbs NOx at the initial start-up, so that the stored NOx is removed by a reducing agent component in the exhaust gas, afterwards when it becomes a high temperature/reduction atmosphere.

However, in order to cope with fuel economy and the stringent regulations, as high efficiency engine technology is applied, gradually lowering an exhaust gas temperature, there is a limit to reducing NOx discharged in a cold start region, a low temperature region at the initial start- up period.

### SUMMARY OF THE INVENTION

In preferred aspects, provided are a NOx reducing catalyst having excellent NOx reduction performance in a cold start region, which is a low temperature region at the initial start-up period, and an exhaust gas purification system for a vehicle including the NOx reducing catalyst.

In an aspect is provided an NOx reducing catalyst that includes a carrier including a cerium-zirconium composite oxide and palladium supported on the carrier. In particular, the catalyst may include the palladium in an amount of about 1 wt% to about 5 wt% based on the total weight of the catalyst.

The cerium-zirconium composite oxide may be a composite or solid solution including cerium oxide (CeO₂) and zirconium oxide (ZrO₂).

The cerium-zirconium composite oxide may include cerium oxide in an amount of about 30 wt% to about 60 wt% based on the total weight of the cerium-zirconium composite oxide.

The cerium-zirconium composite oxide may further include a functional element including one or more selected from the group consisting of La, Y, Pr, and Nd.

The cerium-zirconium composite oxide may include a functional element in an amount of about 5 wt% to about 12 wt% based on the total weight of the cerium-zirconium composite oxide.

In an aspect, provided is the exhaust gas purification system for a vehicle. In an exhaust gas purification system for a vehicle, which is equipped on an exhaust pipe connected to an exhaust side of an engine of a vehicle to purify exhaust gas of the engine, the exhaust gas purification system for a vehicle includes a housing disposed on the exhaust pipe to receive the exhaust gas discharged from the engine and to discharge the received exhaust gas to the rear; a front end catalyst built in the housing to primarily purify the exhaust gas introduced through a front end of the housing thereinto; and a rear end catalyst built in the housing to secondarily purify the exhaust gas passing through the front end catalyst before flowing out to a rear end of the housing.

The front end catalyst may include a carrier including a cerium-zirconium composite oxide, and palladium supported on the carrier, and the catalyst may include the palladium in an amount of about 1 wt% to about 5 wt% based on the total weight of the front end catalyst.

The rear end catalyst may include a carrier and a noble metal supported on the carrier.

The rear end catalyst may include a carrier including one or more selected from the group consisting of ceria (CeO₂), alumina (Al₂O₃), titania (TiO₂), and zirconia (ZrO₂).

The rear end catalyst may include a noble metal including one or more selected from the group consisting of platinum (Pt), palladium (Pd), rhodium (Rh), and gold (Au).

The rear end catalyst may be supported on a carrier, and may further include a nitrogen oxide absorbing material including one or more selected from the group consisting of barium (Ba), ceria (CeO₂), and potassium (K).

The exhaust gas purification system for a vehicle may include about 50 parts by weight to about 90 parts by weight of the rear end catalyst and about 10 parts by weight to about 50 parts by weight of the front end catalyst.

Also provided is a vehicle comprising the NOx reducing catalyst as described herein, or exhaust gas purification system as described herein.

According to various exemplary embodiments, the NOx reducing catalyst may exhibit excellent performance of reducing NOx discharged in a cold start region, a low temperature region at the initial start-up period.

### BRIEF DESCRIPTION OF THE DRAWINGS

FIG. 1 is a schematic view showing an exemplary exhaust gas purification system for a vehicle according to an exemplary embodiment of the present invention.

FIG. 2 is a graph showing the NOx storage performance results of catalysts prepared in the example before and after the degradation of the catalysts.

FIG. 3 is a graph showing the heat resistance results of an exemplary catalyst having a palladium content of 2 wt% in the example and CeO₂ at 500° C. and 800° C.

FIG. 4 is a graph showing the heat resistance results of the catalysts according to the example depending on a palladium content.

FIG. 5 is a graph showing the NOx storage performance results before and after the degradation of the catalysts according to the example.

FIG. 6 is a graph showing the NOx storage performance results before and after the degradation of the catalysts according to the example depending on a functional element.

### DETAILED DESCRIPTION

The advantages and features of the present disclosure and the methods for accomplishing the same will be apparent from the embodiments described hereinafter with reference to the accompanying drawings. However, an implemented form may not be limited to example embodiments disclosed below. Unless otherwise defined, all terms (including technical and scientific terms) used herein have the same meaning as commonly understood by one of ordinary skill in the art. In addition, terms defined in a commonly used dictionary are not to be ideally or excessively interpreted unless explicitly defined.

In addition, unless explicitly described to the contrary, the word “comprise,” and variations such as “comprises” or “comprising,” will be understood to imply the inclusion of stated elements but not the exclusion of any other elements.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further, the singular includes the plural unless mentioned otherwise.

In an aspect, provided is a NOx reducing catalyst including a carrier including a cerium-zirconium composite oxide, and palladium supported on the carrier.

The palladium may be supported on the cerium-zirconium composite oxide and may oxidize hydrocarbon (HC) and carbon monoxide (CO), increasing a nitrogen oxide (NOx) storage amount of the cerium-zirconium composite oxide, and improving heat resistance.

The catalyst may include palladium an amount of about 1 wt% to about 5 wt%, for example, about 2 wt% to about 3 wt% based on the total weight of an NOx reducing catalyst. When the palladium is included in an amount of less than about 1 wt%, the nitrogen oxide (NOx) storage amount may be reduced, but when the palladium is included in an amount of greater than about 5 wt%, since polydispersity of the palladium is deteriorated, a nitrogen oxide (NOx) absorption amount cannot but be increased.

The cerium-zirconium composite oxide absorbs nitrogen oxide (NOx) at a low temperature of less than or equal to about 150° C. but desorbs the nitrogen oxide (NOx) at greater than or equal to about 250° C. The cerium-zirconium composite oxide may be a composite or a solid solution of cerium oxide (CeO₂) and zirconium oxide (ZrO₂), for example, a solid compound in which the cerium oxide (CeO₂) and the zirconium oxide (ZrO₂) form a completely uniform phase, e.g., the solid solution.

The cerium-zirconium composite oxide may include the cerium oxide in an amount of about 30 wt% to about 60 wt%, for example, about 40 wt% to about 50 wt% based on the total weight of the cerium-zirconium composite oxide. When the cerium-zirconium composite oxide includes the cerium oxide in an amount of less than about 30 wt%, a nitrogen oxide (NOx) storage amount may be reduced, but when the cerium oxide is included in an amount of greater than about 60 wt%, the cerium-zirconium composite oxide may be degraded, deteriorating catalyst performance.

The cerium-zirconium composite oxide may further include a functional element including La, Y, Pr, Nd, or a combination thereof. The functional element may further improve the nitrogen oxide (NOx) storage amount of the cerium-zirconium composite oxide.

The cerium-zirconium composite oxide may include the functional element in an amount of about 5 wt% to about 12 wt% based on the total weight of the cerium-zirconium composite oxide. When the functional element is included in an amount of less than 5 wt%, the nitrogen oxide (NOx) storage amount may be reduced, but when the functional element is included in an amount of greater than 12 wt%, the nitrogen oxide (NOx) storage amount may not be greatly increased, and because an element such as Y, Nd, or the like is an expensive material, a cost may increase.

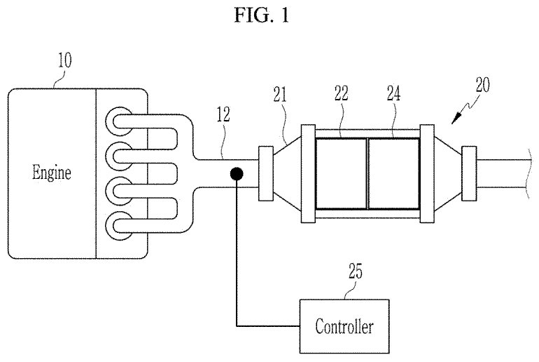

FIG. 1 is a schematic view showing an exemplary exhaust gas purification system for a vehicle according to an exemplary embodiment.

Hereinafter, referring to FIG. 1, the exhaust gas purification system for a vehicle is illustrated.

As shown in FIG. 1, the exhaust gas purification system 20 for a vehicle is provided on an exhaust pipe 12 connected to an exhaust side of an engine 10 to purify the exhaust gas of the engine 10, and includes a housing 21 disposed on the exhaust pipe 12, a front end catalyst 22 and a rear-end catalyst 24 built in the housing 21, and a controller 25 for controlling a concentration of unburned fuel contained in the exhaust gas. In FIG. 1, a portion of the housing 21 is cut to show a configuration of the front end catalyst 22 and the rear end catalyst 24.

The engine 10 converts chemical energy into mechanical energy by burning a mixture of fuel and air. The engine 10 includes a plurality of combustion chambers that generate driving power by burning the fuel, is connected to an intake manifold to receive the air into the combustion chambers, collects the exhaust gas generated during the combustion in an exhaust manifold, and discharges the exhaust gas. The combustion chambers are equipped with an injector to inject the fuel into themselves.

The exhaust pipe 12 is connected to the exhaust side of the engine 10 to discharge the exhaust gas emitted from the engine 10. On the other hand, the exhaust pipe 12 may be extend rearward along an under floor of the vehicle to discharge the exhaust gas to the rear of the vehicle. Disposition of the exhaust pipe 12 and connection thereof to the exhaust side of the engine 10 are well known to those who have an ordinary skill (hereinafter, those skilled in the art) and thus will not be described in detail.

The exhaust gas discharged from the engine 10 passes the exhaust gas purification system 20 through the exhaust pipe 12. In addition, the exhaust gas passing the exhaust gas purification system 20 sequentially passes the front end catalyst 22 and the rear end catalyst 24. In other words, a front end of the housing 21 is connected to the engine 10 by the exhaust pipe 12 to receive the exhaust gas, and a rear end of the housing 21 is communicated with the exhaust pipe 12 to discharge the exhaust gas passing through the exhaust gas purification system 20 to the rear of the vehicle. The front and rear ends of a constituent element may be determined based on a flow of the exhaust gas, and the exhaust gas is defined to flow from the front end of the constituent element to the rear end.

The front end catalyst 22 functions to primarily purify the exhaust gas introduced into the housing 21 through the front end of the housing 21. In addition, the front end catalyst 22 oxidizes hydrocarbon (HC) and carbon monoxide (CO) and simultaneously, absorbs nitrogen oxide (NOx).

The front end catalyst 22 may be an NOx reducing catalyst according to an exemplary embodiment. The description of the NOx reducing catalyst is the same as described above and will not be repeated.

The rear end catalyst 24 is disposed on a rear end of the front end catalyst 22 and functions to secondarily purify the exhaust gas passing through the front end catalyst 22 before discharged through the rear end of the housing 21.

The rear end catalyst 24 is supported with a noble metal on a carrier. The noble metal plays a role of oxidizing nitrogen monoxide (NO) into nitrogen dioxide (NO₂) in a lean combustion region. The noble metal may include specifically platinum (Pt), palladium (Pd), rhodium (Rh), gold (Au), or a combination thereof. The noble metal may be supported in an amount of about 0.1 wt% to about 10 wt% based on the total weight of the rear end catalyst 24. When the noble metal is too little supported, oxidization capability may be insufficient, but when the noble metal is too much supported, nitrogen oxide (NOx) absorption performance may be insufficient.

The carrier plays a role of supporting the noble metal. For example, the carrier may include ceria (CeO₂), alumina (Al₂O₃), titania (TiO₂), zirconia (ZrO₂), or a combination thereof. The carrier may be included in an amount of about 65 wt% to about 95 wt% based on the total weight of the rear end catalyst 24.

The rear end catalyst 24 may further include a nitrogen oxide absorbing material supported on a carrier together with the noble metal. The nitrogen oxide absorbing material plays a role of storing nitrogen oxides (NOx) oxidized by the noble metal in the lean combustion region.

For example, the nitrogen oxide storage material may be barium (Ba), ceria (CeO₂), potassium (K), or a combination thereof. The nitrogen oxide absorbing material may be supported in an amount of about 1 wt% to about 30 wt% based on the total weight of the rear end catalyst 24. When the nitrogen oxide absorbing material is too little supported, absorption performance may be insufficient, but when the nitrogen oxide absorbing material is too much supported, a region for supporting the noble metal is relatively reduced, and thereby, oxidation performance may be insufficient.

The exhaust gas purification system 20 for a vehicle may include 24 about 50 parts by weight to about 90 parts by weight of the rear end catalyst and about 10 parts by weight to about 50 parts by weight of the front end catalyst 22. When the front end catalyst 22 is too little included, nitrogen oxide (NOx) absorption performance at a low temperature may be deteriorated, but when the front end catalyst 22 is too much included, the rear end catalyst 22 may be relatively less included, resulting in deteriorating the nitrogen oxide (NOx) oxidation performance at a high temperature.

The controller 25 is connected to the exhaust pipe 12 at the front end of the housing 21 to control a temperature of the exhaust gas flowing into the housing 21 and a concentration of the unburned fuel contained in the exhaust gas according to a speed of the vehicle.

The controller 25 may sense the temperature of the exhaust gas flowing through the exhaust pipe 12 connected to the housing 21 by a temperature sensor connected thereto and also the speed of the vehicle by a speed sensor connected thereto. In addition, an oxygen sensor may be connected to the controller 25 to collect information of an air-fuel ratio (λ).

The controller 25 controls the concentration of the unburned fuel contained in the exhaust gas flowing into the housing 21 to become slightly lean after starting the engine 10. The controller controls the leanness of the concentration of the unburned fuel contained in the exhaust gas flowing into the housing 21 to become different according to the temperature of the exhaust gas and the vehicle speed.

The controller 25 ends the leanness control, when the temperature of the exhaust gas is greater than or equal to a predetermined temperature (T), and the vehicle speed is greater than or equal to a predetermined speed (V).

The controller 25 may control the air-fuel ratio (λ) of the unburned fuel contained in the exhaust gas flowing into the housing 21 to less than about 1.08, when the exhaust gas temperature is less than the predetermined temperature (T), and the vehicle speed is less than the predetermined speed (V). The predetermined temperature (T) may be greater than or equal to about 450° C. and less than about 500° C., and the predetermined speed (V) may be about 3 km/h.

In addition, the controller 25 may control the air-fuel ratio (λ) of the unburned fuel contained in the exhaust gas flowing into the housing 21 to less than about 1.05, when the temperature of the exhaust gas flowing into the housing 21 is less than the predetermined temperature (T), the vehicle speed may be less than the predetermined speed (V), and a vehicle gear is a running (D) state.

### EXAMPLE

Hereinafter, specific examples of the invention are described. However, the examples described below are for illustrative purposes only, and the scope of the invention is not limited thereto.

Example: Preparation of NOx Reducing Catalyst

A cerium-zirconium composite oxide was prepared in a co-precipitation method. Specifically, cerium nitrate hexahydrate (Ce(NO₃)36H₂O) and a zirconyl chloride (ZrOCl₂ 8H₂O) precursor in a desired weight ratio of CeO₂:ZrO₂ were dissolved in distilled water. Subsequently, when an ammonia aqueous solution was added to the solution, until pH became 10, the cerium-zirconium hydroxide was generated as precipitates. The produced precipitates were filtered and then, washed with distilled water, until the pH did not change. The washed precipitates were fired at a temperature of 500° C. for 5 hours to obtain the cerium-zirconium composite oxide.

Experimental Example 1: Performance Evaluation of Catalyst according to Palladium Content

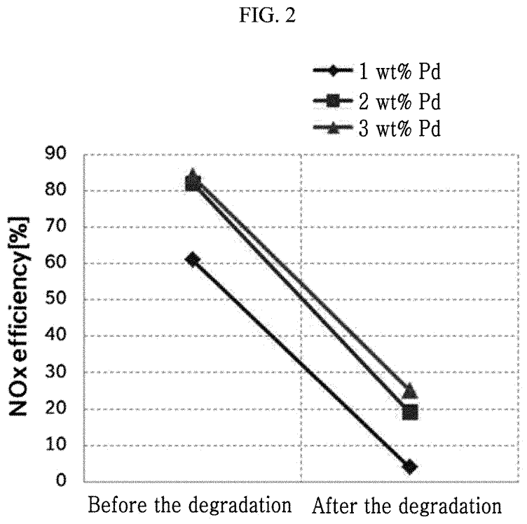

Catalysts were prepared by adjusting a palladium content into 0.5 wt%, 1 wt%, 2 wt%, 3 wt%, 4 wt%, and 5 wt% based on the total weight of the catalyst in the example, and then, NOx storage performance and heat resistance of the catalysts were measured, and the results are shown in FIGS. 2 to 4.

FIG. 2 is a graph showing the NOx storage performance results of the catalysts prepared in the example before and after the degradation of the catalysts. The degradation of the catalysts was carried out by alternately changing a fuel lean atmosphere and a fuel rich atmosphere with an exhaust gas-simulating gas at a temperature of 1000° C. for 24 hours (Lean/Rich cyclic aging).

As shown in FIG. 2, as the palladium content was increased within the range of about 1 wt% to about 5 wt%, the NOx storage performance of a catalyst increased.

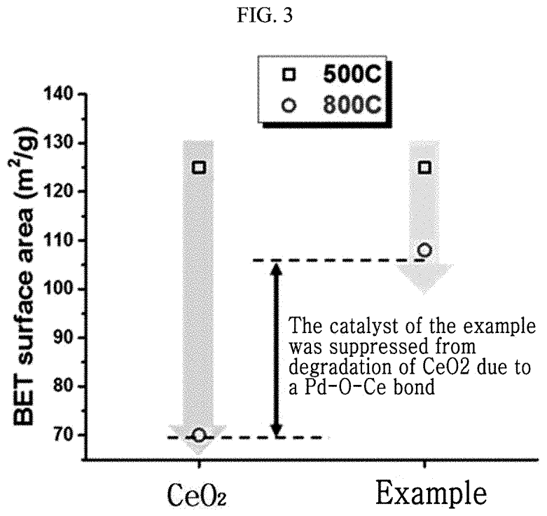

FIG. 3 is a graph showing the heat resistance results of a catalyst having a palladium content of 2 wt% in the example and CeO₂ at a temperature of 500° C. and 800° C.

As shown in FIG. 3, the catalyst of the example was suppressed from degradation of CeO₂ due to a Pd-O-Ce bond.

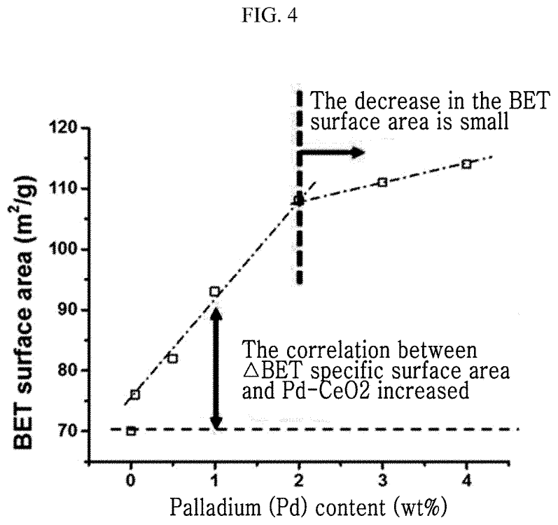

FIG. 4 is a graph showing the heat resistance results of the catalysts according to the example depending on a palladium content.

As shown in FIG. 4, when the palladium content was less than 2 wt%, there was a high correlation between ΔBET specific surface area and Pd-CeO₂, but when the palladium content was greater than or equal to 2 wt%, the correlation between ΔBET specific surface area and Pd-CeO₂ decreased.

Experimental Example 2: Performance Evaluation of Catalyst according to Palladium Content

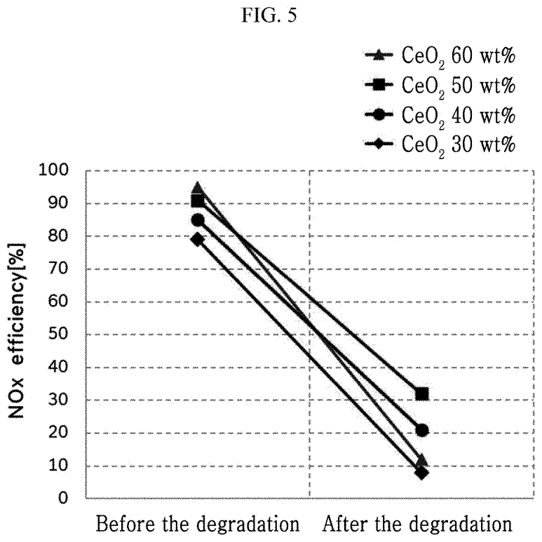

Catalysts were respectively prepared to include 30 wt%, 40 wt%, 50 wt%, and 60 wt% of cerium oxide based on the total weight of the catalyst in the example by adjusting the amount of the cerium oxide, and then, NOx storage performances of the catalysts were measured, and the results are shown in FIG. 5.

FIG. 5 is a graph showing the NOx storage performance results of the catalysts according to the example before and after the degradation. The degradation of the catalysts was carried out by alternately changing the fuel lean atmosphere and the fuel rich atmosphere at a temperature of 1000° C. for 24 hours with an exhaust gas-simulating gas (Lean/Rich cyclic aging).

As shown in FIG. 5, as a content of cerium oxide was increased in the cerium-zirconium composite oxide, the NOx storage performance was improved, but when the content of cerium oxide was increased over 50 wt%, the performance was deteriorated by the degradation of the cerium-zirconium composite oxide.

Experimental Example 3: Performance Evaluation of Catalyst according to Functional Elements

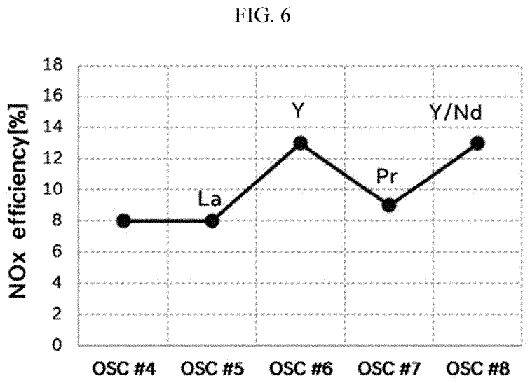

In the example, catalysts were prepared by additionally adding an element including La, Y, Pr, Nd, or a combination thereof in amounts shown in Table 1 during the preparation of the cerium-zirconium composite oxide, and NOx storage performances of the catalysts were measured, and the results are shown in FIG. 6.

FIG. 6 is a graph showing the NOx storage performance results of the catalysts prepared in the example depending on the functional elements.

TABLE 1

| | Ce | Zr | La | Y | Pr | Nd |
|---|---|---|---|---|---|---|
| | (wt %) | (wt %) | (wt %) | (wt %) | (wt %) | (wt %) |
| OSC #4 | 40 | 55 | 5 | — | — | — |
| OSC #5 | 40 | 50 | 10 | — | — | — |
| OSC #6 | 40 | 43 | 5 | 12 | — | — |
| OSC #7 | 40 | 45 | 5 | — | 10 | — |
| OSC #8 | 40 | 42 | 5 | 5 | — | 8 |

As shown in FIG. 6 and Table 1, when Y and Nd elements were further added to the cerium-zirconium composite oxide, the NOx storage performances of the catalysts were much improved.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope greater than or equal to appended claims.

Description of Symbols

| | |
|---|---|
| 10: engine | 12: exhaust pipe |
| 20: exhaust gas purification system | 21: housing |
| 22: front end catalyst | 24: rear end catalyst |
| 25: controller | |

What is claimed is:

1. An NOx reducing catalyst, comprising:
a carrier comprising a cerium-zirconium composite oxide, and
palladium supported on the carrier,
wherein the catalyst comprises the palladium in an amount of about 1 wt% to about 5 wt% based on the total weight of the catalyst.

2. The NOx reducing catalyst of claim 1, wherein the cerium-zirconium composite oxide is a composite or solid solution comprising cerium oxide (CeO₂) and zirconium oxide (ZrO₂).

3. The NOx reducing catalyst of claim 1, wherein the cerium-zirconium composite oxide comprises cerium oxide in an amount of about 30 wt% to about 60 wt% based on the total weight of the cerium-zirconium composite oxide.

4. The NOx reducing catalyst of claim 1, wherein the cerium-zirconium composite oxide further comprises a functional element comprising one or more selected from the group consisting of La, Y, Pr, and Nd.

5. The NOx reducing catalyst of claim 1, wherein the cerium-zirconium composite oxide comprises a functional element in an amount of about 5 wt% to about 12 wt% based on the total weight of the cerium-zirconium composite oxide.

6. An exhaust gas purification system for a vehicle provided on an exhaust pipe connected to the exhaust side of the engine to purify the exhaust gas of the engine, comprising,
a housing disposed on the exhaust pipe to receive the exhaust gas discharged from the engine and to discharge the received exhaust gas to the rear;
a front end catalyst built in the housing to primarily purify the exhaust gas introduced into the housing through a front end of the housing; and
a rear end catalyst built in the housing to secondarily purify the exhaust gas passing through the front end catalyst before flowing out to the rear end of the housing,
wherein the front end catalyst comprises:
a carrier comprising a cerium-zirconium composite oxide and
palladium supported on the carrier,
wherein the catalyst comprises the palladium in an amount of about 1 wt% to about 5 wt% based on the total weight of the front end catalyst.

7. The exhaust gas purification system for a vehicle of claim 6, wherein
the rear end catalyst comprises a carrier comprising one or more selected from the group consisting of ceria (CeO₂), alumina (Al₂O₃), titania (TiO₂), and zirconia (ZrO₂), and
a noble metal supported on the carrier and comprising one or more selected from the group consisting of platinum (Pt), palladium (Pd), rhodium (Rh), and gold (Au).

8. The exhaust gas purification system for a vehicle of claim 7, wherein the rear end catalyst further comprises a nitrogen oxide absorbing material supported on the carrier and comprising one or more selected from the group consisting of barium (Ba), ceria (CeO₂), and potassium (K).

9. The exhaust gas purification system for a vehicle of claim 6, wherein the exhaust gas purification system for a vehicle comprises about 50 parts by weight to about 90 parts by weight of the rear end catalyst and about 10 parts by weight to about 50 parts by weight of the front end catalyst.

10. A vehicle comprising an NOx reducing catalyst of claim 1.
